(19) United States
(12) Patent Application Publication
(10) Pub. No.: US 2006/0074982 A1
(43) Pub. Date: Apr. 6, 2006

(54) Method for comparing tabular data

(76) Inventors: Joseph M. Spodaryk, Bordertown, NJ (US); Peter Vandenberg, Toms River, NJ (US); Peter Westervelt, Toms River, NJ (US)

Correspondence Address: NAVAL AIR WARFARE CENTER AIRCRAFT;DIVISION OFFICE OF COUNSEL BLDG 435, SUITE A, 47076 LILJENCRANTZ ROAD UNIT 7, PATUXENT RIVER, MD, 20670, US

(21) Appl. No.: 10/956,522

(22) Filed: Sep. 23, 2004

(51) Int. Cl. G06F 17/00

(52) U.S. Cl. 707/104.1

(57) ABSTRACT

A computer implemented method that allows users to easily compare electronic files of tabular data. Files generated by various computer programs, including spreadsheets and databases, may be compared with one another. The results of the comparisons may be viewed, printed, saved and exported in various formats. The invention is particularly suited to use with computer programs such as Microsoft® Access.

### STATEMENT OF GOVERNMENT INTEREST

The invention described herein may be manufactured and used by or for the Government of the United States of America for government purposes without the payment of any royalties therefor.

### BACKGROUND OF THE INVENTION

The invention relates in general to computer programs for manipulating data and in particular to a method, implemented on a general purpose computer, for comparing files of tabular data.

Tabular data is often stored in electronic form for access and manipulation using a computer. The tabular data may take the form of, for example, spreadsheets and databases. Very large quantities of tabular data may be stored in these electronic “files.” Often it is desired to compare two or more electronic data files. At present, data file comparison is typically accomplished by first downloading paper copies of the files to be compared. Then, a human examines the data files for the particular comparison that is desired. This is an extremely labor intensive and time consuming task.

The present invention provides a method, implemented with a general purpose computer, for comparing electronic data files using the speed and power of the computer.

The invention will be better understood, and further objects, features, and advantages thereof will become more apparent from the following description of the preferred embodiments, taken in conjunction with the accompanying drawings.

### BRIEF DESCRIPTION OF THE DRAWINGS

In the drawings, which are not necessarily to scale, like or corresponding parts are denoted by like or corresponding reference numerals.

FIG. 1 is a flow chart of the inventive method.

FIG. 2 shows the results display.

### DETAILED DESCRIPTION OF THE PREFERRED EMBODIMENTS

The present invention is a computer implemented method that allows users to easily compare electronic files of tabular data. Files generated by various computer programs, including spreadsheets and databases, may be compared with one another. The results of the comparisons may be viewed, printed, saved and exported in various formats. The invention is particularly suited to use with computer programs such as Microsoft® Access.

The inventive method includes several steps for creating a comparison. First, the user identifies the files to be compared. Then, the user selects a “key” field for each file. A key field is a data field. The key fields selected for each file must be an identical variety of data field. After selection of the key fields, the user may optionally select additional fields to be compared. After the key fields have been selected (and any optional additional fields), the user can view the results of various categories of comparison, or count the records in each category.

When viewing the results of a comparison, the user may use the built in features of the underlying platform (such as Access) to sort or filter the results, view only selected fields, print the data, or save the data in another format (such as an Excel spreadsheet). In the final step of the method, the user has the option of giving the comparison a name and saving it. The saved comparisons may be reopened later.

Because it is impossible to anticipate all of the types of files that users may want to compare, the method attempts comparisons on any files that can be linked into the underlying software platform (such as Microsoft® Access). Thus, the method is not limited to working only with a few specific types of files. While this approach offers great flexibility, it does allow some situations where unanticipated combinations of input files can cause the method to fail. For example, if the method is implemented with Microsoft® Access 97 as the underlying platform, the method may not be able to compare files that were created with Microsoft® Office 2000.

Step by Step Procedure

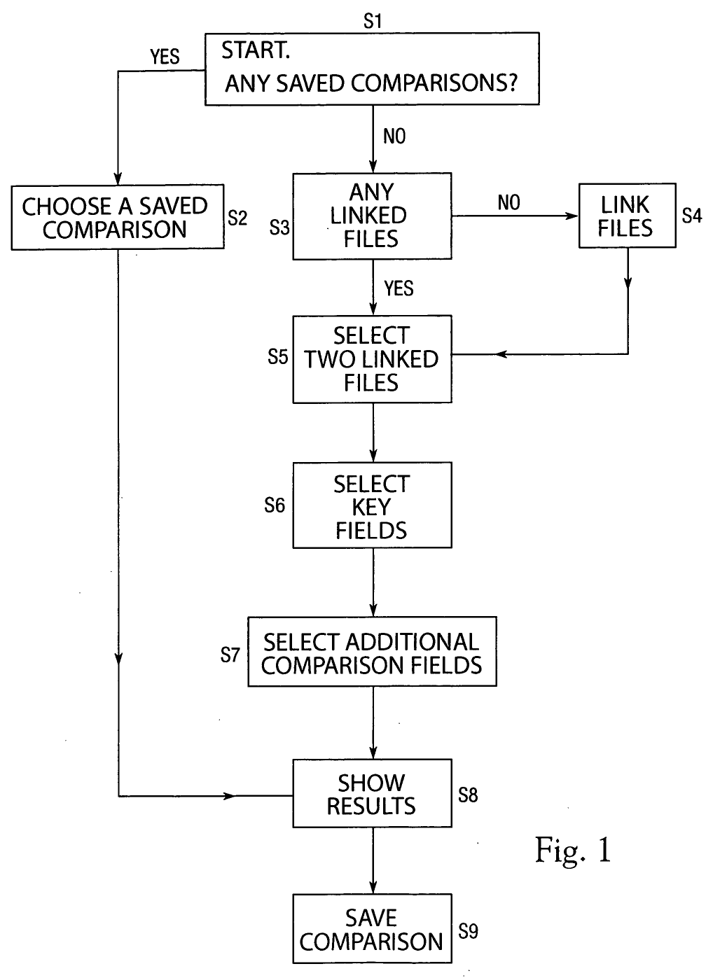

The context of the step by step procedure discussed below is that of operating a computer that is loaded with a computer program that embodies the inventive method. FIG. 1 is a flow chart of the inventive method.

In step S1, the program starts and determines if there are any saved comparisons. If there are saved comparisons, the saved comparisons are displayed. In step S2, the user may choose one of the saved comparisons. To open a saved comparison, click on the name of the comparison to select it, then click the [Open Saved Comparison] button. The program loads the saved comparison, checks that the files are still available, and skips ahead to step S8 where the results may be viewed. The name of the comparison will appear in a title bar on the display screen. To delete a saved comparison, click on the name of the comparison to select it, then click the [Delete Saved Comparison] button. The comparison will be removed from the list.

It is important to note that only the definition of a comparison is saved, not the results of the comparison. The results of a comparison are recalculated each time the comparison is viewed. If the data in the underlying files change, so do the results of the comparison. If, however, there are no saved comparisons, the program skips directly to step S3.

To begin creating a new comparison, click the [Next] button to advance to step S3. In step S3, the program determines if there are any “linked” files. If yes, the program displays a list of the files that have been “linked” or made available for the program to work on. If the two files to be compared have already been linked, go to step S5 and select two files from the list by clicking on them, then click the [Next] button to advance to step S6.

If a file does not appear on the list, it must first be linked. In step S4, files are linked. Clicking the [Link File] button opens the Link dialog, which allows the user to navigate to the file and link it. Depending on the type of file being linked, the user will be prompted to enter additional information. In the case of spreadsheet files, the user will be asked if the “First Row Contains Column Headings.” Be sure to check this option if the first row of data does in fact contain field names.

For database files the user may be asked to identify a matching index file. This is optional, but if an appropriate index file is available, including it may allow the comparison to run more quickly. Text files may be divided into fields by delimiters such as commas or tabs, or the fields may have fixed widths padded out with spaces.

Once the file has been linked it will appear in the list of linked files, and can be used in comparisons. The user then proceeds to step S5. To remove linked files from the list, select them by clicking on them, then click [Remove Link]. Note, however, that if a link that is required by a saved comparison is removed, that saved comparison will no longer work.

Once the appropriate files have been linked, the user selects two files to be compared by clicking on them, and then clicking the [Next] button to advance to step S6. In step S6 two lists are displayed showing the fields in the two files. Select one key field from each file and click the [Next] button to advance to step S7. The key fields must be identical data fields, that is, the data therein must of the same variety.

The key fields are used to match up records in the comparison. An example of a key field is the use of social security numbers to match up two files containing employee information. A poor choice of a key field would be to use the employees' first names, because there could be many duplicates in each file, thereby resulting in a meaningless comparison.

The key fields do not have to have the same name, although the underlying variety of data must be the same. As an example of a key field for bar codes, one key field could be called “Bar Code” and the other could be called “BC.” It is also not necessary for the representation of the data in the key fields to be of the same type. For example, data fields in two files may represent a date. In one file, the date data field may be represented by a combination of text and numerals and in the other file the date data field may be represented by numerals only. The method will attempt to coerce the fields to match. Some comparisons are, however, impossible, such as currency (money) with date. In addition, some types of fields cannot be used as key fields, such as Hyperlinks and Memos.

Optionally, in step S7 the user can select additional fields to compare, in addition to the key fields already selected. Selecting additional fields has the effect of reducing the number of records that will match between the two files, that is, narrowing the comparison. The user selects one field from each file and clicks the [ [symbol] ] button to move that pair of fields to the list of comparisons. This step may be repeated as needed to add more pairs of fields to the list of comparisons. To remove a pair of fields from the list of comparisons, select it and click the [ [symbol] ] button.

In the example of comparing two files of employee information, with the social security number fields having been selected as the key fields, the user might choose to additionally compare the first name, the last name, and the date of hire fields. As in the case of key fields, the fields being compared do not have to have the exact same name or representation of data, but the underlying variety of data must still be the same. When the user is finished adding pairs of fields to be compared, click the [Next] button to advance to step S8.

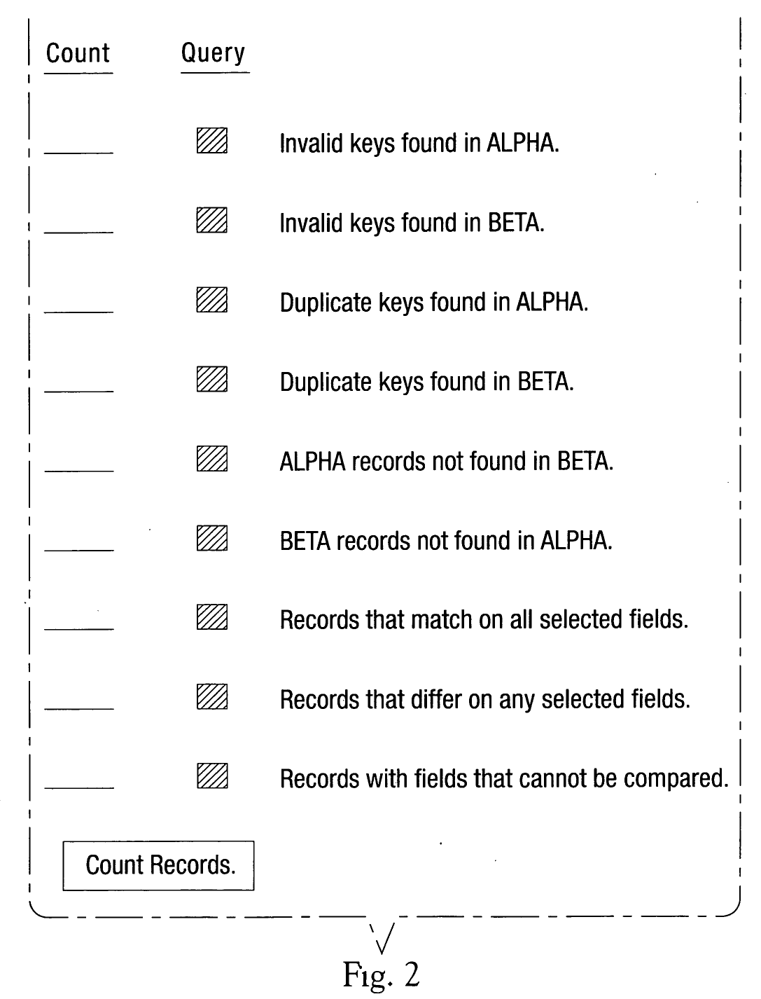

In step S8, various categories of results of the comparison are listed. FIG. 2 shows a results display for two hypothetical files named ALPHA and BETA. For each category of result there is a button in the QUERY column that can be clicked to display the specific results. Also, for each category there is a field in the COUNT column where the count of records can be displayed. The count fields are initially blank, but can be filled in by clicking the [Count Records] button.

Up to nine separate categories of results may be listed depending on the types of fields included in the comparison. Following are detailed descriptions of the categories:
(1) “Invalid keys found in ______”. This category is listed twice (once for each file). The name of the file appears in the blank. Records that appear in this result are those with null values in their key fields, or with values in their key fields that cannot be converted to match the type of the other file's key field. For example, if the key field selected for one file is defined as being only numeric, and the other file's key field is defined as being a combination of numeric and text, any records in the second file that have only letters in the key field will be invalid because they can not be compared with the numeric field of the first file.
(2) “Duplicate keys found in ______”. This category is listed once for each file, with the names of the linked files appearing in the blank. Records that appear in this result are those that have a value in their key fields that appears in more than one record. The values of the key fields and the number of duplicates of each value are listed in the result. Records with duplicate key values cannot be compared correctly and may give unexpected results in the later categories.
(3) “records not found in ______”. This category is listed once for the records of each file that have no matching key in the other file. The names of the linked files will appear in the blanks.
(4) “Records that match on all selected fields”. This category includes only those records that have matching keys and match on all additional fields selected in step S7.
(5) “Records that differ on any selected fields”. This category includes only those records that have matching keys, but do not match on all additional fields selected in step S7.
(6) “Records with fields that could not be compared”. This category includes only those records that have matching keys, but have “invalid” values in other fields, making it impossible to carry out the additional comparisons selected in step S7. For example, if one of the fields being compared was defined as a date, and the matching field in the other file allowed free form text, some records in the second file may contain entries that the program cannot interpret as a date. This category is only listed if one or more fields selected in step S7 were of different data varieties.

To view the results in a specific category the user clicks on the corresponding button in the QUERY column. The results will be displayed in “Datasheet View”, where the built in features of the underlying platform (such as Microsoft® Access) can be used to arrange, sort, filter, print or export the data. To save the comparison, click the [Next] button to advance to step S9.

In step S9 the user has the option of saving the comparison. To save the comparison, type a meaningful name into the Comparison Name field and click the [Save Comparison] button. The name of the comparison will appear in the title bar. Note that only the definition of the comparison is saved. This definition includes the names of the two linked files, the names of the two key fields, and any additional fields selected in step S7. When the results of the comparison are viewed in step S8, they are based on the current contents of the files, not on the content of the files when the comparison was saved. If the linked files used by the comparison are later removed, or if changes are made to the structure of the files, the saved comparison will no longer work.

While the invention has been described with reference to certain preferred embodiments, numerous changes, alterations and modifications to the described embodiments are possible without departing from the spirit and scope of the invention as defined in the appended claims, and equivalents thereof.

What is claimed is:

1. A method of comparing data files, comprising:
selecting at least a first and a second data file to compare;
linking any of the first and second data files that are not linked;
selecting a key field in each of the first and second data files to create a comparison, the key fields representing a same variety of data; and
using the key fields, comparing the first and second data files with a computer to obtain comparison results.

2. The method of claim 1 wherein the comparison results comprise a number of records in the first data file having an invalid key field and a number of records in the second data file having an invalid key field.

3. The method of claim 2 wherein the comparison results comprise a visual display of the records in the first data file having an invalid key field and a visual display of the records in the second data file having an invalid key field.

4. The method of claim 1 wherein the comparison results comprise a number of records in the first data file having a same value in the key field and a number of records in the second data file having a same value in the key field.

5. The method of claim 4 wherein the comparison results comprise a visual display of the records in the first data file having a same value in the key field and a visual display of the records in the second data file having a same value in the key field.

6. The method of claim 1 wherein the comparison results comprise a number of records in the first data file that have no matching key field in the second data file and a number of records in the second data file that have no matching key field in the first data file.

7. The method of claim 6 wherein the comparison results comprise a visual display of records in the first data file that have no matching key field in the second data file and a visual display of records in the second data file that have no matching key field in the first data file.

8. The method of claim I wherein the comparison results comprise a number of records in the first data file that have a matching key field in the second data file and a visual display of the records in the first data file that have a matching key field in the second data file.

9. The method of claim I further comprising saving the comparison.

10. A method of comparing data files, comprising:
selecting at least a first and a second data file to compare;
linking any of the first and second data files that are not linked;
selecting a key field in each of the first and second data files to create a comparison, the key fields representing a same variety of data;
selecting at least one additional field in each of the first and second data files to create a narrowed comparison, the additional fields representing a same variety of data; and
using the key fields and the at least one additional fields, comparing the first and second data files with a computer to obtain comparison results.

11. The method of claim 10 wherein the comparison results comprise a number of records in the first data file having an invalid key field and a number of records in the second data file having an invalid key field.

12. The method of claim 11 wherein the comparison results comprise a visual display of the records in the first data file having an invalid key field and a visual display of the records in the second data file having an invalid key field.

13. The method of claim 10 wherein the comparison results comprise a number of records in the first data file having a same value in the key field and a number of records in the second data file having a same value in the key field.

14. The method of claim 13 wherein the comparison results comprise a visual display of the records in the first data file having a same value in the key field and a visual display of the records in the second data file having a same value in the key field.

15. The method of claim 10 wherein the comparison results comprise a number of records in the first data file that have no matching key field in the second data file and a number of records in the second data file that have no matching key field in the first data file.

16. The method of claim 15 wherein the comparison results comprise a visual display of records in the first data file that have no matching key field in the second data file and a visual display of records in the second data file that have no matching key field in the first data file.

17. The method of claim 10 wherein the comparison results comprise a number of records in the first data file that have a matching key field and all matching additional fields in the second data file, and a visual display of the records in the first data file that have a matching key field and all matching additional fields in the second data file.

18. The method of claim 10 wherein the comparison results comprise a number of records in the first data file that have a matching key field and at least one non-matching additional field in the second data file, and a visual display of the records in the first data file that have a matching key field and at least one non-matching additional field in the second data file.

19. The method of claim 10 wherein the comparison results comprise a number of records in the first data file that have a matching key field and at least one invalid additional field in the second data file, and a visual display of the records in the first data file that have a matching key field and at least one invalid additional field in the second data file.

20. The method of claim 1 further comprising saving the narrowed comparison.
